(19) United States
(12) Patent Application Publication
(10) Pub. No.: US 2010/0240805 A1
(43) Pub. Date: Sep. 23, 2010

(54) ADHESIVE COMPOSITIONS AND PROCESS FOR PREPARING SAME

(76) Inventors: Todd R. Miller, Eugene, OR (US); Heather E. Clarke, Lancaster, MA (US); Lee R. Johnson, Springfield, OR (US); Rick A. Porter, Garden City, SC (US)

Correspondence Address: HEXION SPECIALTY CHEMICALS, INC., 12650 Directors Drive, Suite 100, Stafford, TX, 77477, US

(21) Appl. No.: 12/564,479

(22) Filed: Sep. 22, 2009

Related U.S. Application Data
(60) Provisional application No. 61/099,307, filed on Sep. 23, 2008.

(51) Int. Cl. C09J 189/00; C09J 101/00

(52) U.S. Cl. 524/13; 524/21; 524/17

(57) ABSTRACT

An adhesive composition substantially free of formaldehyde, comprising at least one bio-derived component, at least one multivalent cation and at least one polymer having a crosslinkable group, wherein the polymer having at least one crosslinkable group is substantially free of epichlorohydrin.

### RELATED APPLICATION DATA

This application claims the benefit of U.S. Provisional Application Ser. No. 61/099,307 filed Sep. 23, 2008, the entire contents of which are hereby incorporated by reference.

### FIELD OF THE INVENTION

This invention relates to an adhesive composition substantially free of formaldehyde. This invention particularly relates to such an adhesive composition additionally comprising at least one bio-derived component.

### BACKGROUND OF THE INVENTION

In the wood products industry and in particular the hardwood plywood industry, there is a growing concern over formaldehyde emissions. As a result many different reduced formaldehyde or non-formaldehyde adhesive systems have emerged. These systems generally include: (i) changing the formulation of the formaldehyde adhesive resin; (ii) adding formaldehyde-scavenging materials directly to the formaldehyde resin; (iii) separately adding formaldehyde-scavenging materials to the wood furnish; (iv) treating panels after manufacture either with a formaldehyde scavenger or by applying coatings or laminates; and (v) changing to an entirely different adhesive system.

While these reduced formaldehyde or formaldehyde free systems solve the problem of formaldehyde they may pose other more dangerous problems or difficulties. One of these problems includes the use of toxic chemicals that are less well understood, and may be bioaccumulative. Other problems include the massive costs that are often needed to redesign and purchase different production equipment due to their unique handling characteristics.

There exists a need for adhesive systems having reagents that are easily combined, and that have reduced variation in physical properties such as pH, viscosity and solids content, and are able to be implemented without the need of toxic chemicals or the need for adhesive users to purchase additional specialized production equipment.

### SUMMARY OF THE INVENTION

In one embodiment there is provided an adhesive composition substantially free of formaldehyde with at least one bio-derived component, at least one multivalent cation and a polymer having at least one crosslinkable group. In this embodiment the polymer having at least one crosslinkable group is substantially free of epichlorohydrin.

In another embodiment, there is provided an article of manufacture comprising an adhesive composition substantially free of formaldehyde with at least one bio-derived component, at least one multivalent cation and a polymer having at least one crosslinkable group and a lignocellulosic component. In this embodiment the polymer having at least one crosslinkable group is substantially free of epichlorohydrin.

In still another embodiment there is provided a process for preparing an adhesive composition substantially free of formaldehyde by contacting a polymer having at least one crosslinkable group with water to produce a primary admixture, mixing into the primary admixture at least one bio-derived component to produce a secondary admixture and mixing into the secondary admixture at least one multivalent cation. In this embodiment the polymer having at least one crosslinkable group is substantially free of epichlorohydrin.

### DETAILED DESCRIPTION

It has been found that an adhesive composition substantially free of formaldehyde comprising at least one bio-derived component, a multivalent cation, a polymer comprising a crosslinkable group and not containing any added epichlorohydrin may be used to prepare an adhesive composition. The adhesive composition may be desirable due to reduced variation in physical properties such as pH, viscosity, and solids content, in addition to cost advantages and may be applied using existing equipment in forest products mills.

For the purposes of this application, the term “substantially free of formaldehyde” means the absence of any purposeful addition of formaldehyde. In addition, substantially free of formaldehyde includes the absence of any compounds that may degenerate to form formaldehyde.

### Bio-Derived Component

The adhesive composition includes a bio-derived component. Such bio-derived components are commercially available as agricultural products and by-products. The bio-derived component may be an animal protein such as soluble blood (e.g., blood albumen) or casein, or alternatively may be a vegetable protein, examples of which include soy protein from soybeans, wheat gluten, wheat flour, corn protein, other vegetable protein, and the like. While glycerin is sometimes considered a bio-derived material, for the purposes of this application, glycerin is not a bio-derived component.

Vegetable protein material may be in the form of ground whole grains, beans, or kernels (including the hulls, oil, protein, minerals, and other components); a meal (extracted or partially extracted); a flour (i.e., generally containing less than about 1.5% wt oil and about 30% wt to about 50% wt carbohydrate); or as an isolate (i.e., a substantially pure protein flour containing less than about 0.5 wt % oil and less than about 5 wt % carbohydrate). As used herein in the specification and claims, “flour” includes within its scope material that fits both the definitions of flour and isolate. The vegetable protein is desirably in the form of a protein flour, wherein the adhesive composition and related wood composite products produced from a flour binder are believed to have more desirable physical properties than those made using a meal which has a coarse texture. The vegetable protein has a mean particle size (i.e., corresponding to the largest dimension) of less than about 0.1 inch (0.25 cm), and more preferably less than about 0.05 inch (0.125 cm). Larger particle sizes may cause the protein material not to be sufficiently soluble or dispersible in the application to produce an adhesive composition suitable for making wood composites with optimum properties. When a protein having a large particle size of greater than about 0.1 inch (0.25 cm) is used and blended with the resin before application to the wood particles, the time required to solubilize the material may be undesirably long.

A protein flour, finely ground, may be particularly useful due to its smaller particle size distribution. The ground vegetable protein, in some embodiments, has a maximum particle size of wheat flour, i.e., about 0.005 inch (about 0.013 cm).

In some embodiments, a bio-derived component of soy may be employed. Protein-rich soybean-derived flours, soy protein isolate, soy protein concentrate and soy flour, which contains about 20 wt % to about 95 wt % protein are each suitable. Of these, ordinary soy flour may be desirable for both its availability and abundance, and thus its cost effectiveness. A wide range of soy flours may be suitable; the particle size of commercially available soybean flour is generally less than about 0.003 inch (0.008 cm). Further, for example, with some commercially available soybean flours about 92% can pass through a 325 mesh screen corresponding to a particle size of less than about 0.003 inch (0.008 cm). In a preferred embodiment the soy flour has greater than 90%, or specifically greater than about 95% of its particles having a size of less than about 100 mesh, specifically less than about 200 mesh, and more specifically less than about 400 mesh.

Additional information on soy protein can be found in, for example, Kirk-Othmer, Encyclopedia of Chemical Technology, Fourth Edition, Volume 22, pp. 591-619 (1997). Examples of commercially available soy proteins are ARCON® AF (available from Archer Daniels Midland Company, Decatur, Ill.), which contains 70% soy protein and HONEYMEAD® (available from CHS, Inc., Inver Grove Heights, Minneapolis), which contains 50% soy protein.

The bio-derived component may be added to the adhesive composition in a range of from about 1% wt to about 60% wt (hereinafter % wt are defined as % wt of the adhesive composition unless otherwise stated). Specifically the bio-derived component may be added at from about 5% wt to about 40% wt, and particularly from about 10% wt to about 25% wt.

### Multivalent Cation

The adhesive composition includes at least one multivalent cation. Multivalent cations are selected from Groups 2, 3, 4, 5, 6, 7, 8, 9, 10 and 11, preferably Groups 2, 7, 8 and 11. Specifically, multivalent cations of Ca++, Mg++, Mn++, Fe++, Fe+++, Cu++, Zn++, Ti++, Ti+++, Ti++++, Cr++, Cr+++, and Al+++ may be used in some embodiments. In one embodiment, the cation is Ca++ mixed into the adhesive composition as CaO or Ca(OH)₂. In some embodiments, both calcium and copper may be used. Other multivalent cation combinations may be used with still other embodiments of the application.

The multivalent cation may be added to the adhesive composition in a range from about 0.0001% wt to about 10% wt. Specifically the multivalent cation is added from about 0.01% wt to about 1% wt, and particularly from about 0.1% wt to about 0.5% wt.

### Polymer Having a Crosslinkable Group

The adhesive composition includes a polymer having at least one crosslinkable group. Suitable crosslinkable groups include but are not limited to carboxylic acid, esters, amides, 1,3 β dicarbonyl, glycidyl ether, oxirane, silane and siloxane. In one embodiment, the crosslinkable group is acetoacetoxyethyl methacrylate (AAEM). The polymer having a crosslinkable group is also substantially free of epichlorohydrin and compounds prepared from epichlorohydrin. For example, in one embodiment, the polymer is free of Azetidinium moieties.

The amount of polymer that may be added to the adhesive composition ranges from about 5% wt to about 80% wt. Specifically, the polymer is added at from about 30% wt to about 65% wt, and particularly from about 40% wt to about 60% wt. The amount of crosslinkable groups within the polymer range from about 1% wt to about 4% wt.

### Flow Modifier

Glycerin may be added as a flow, viscosity or other modifier as commonly known in the art. The glycerin used may be crude glycerin or refined glycerin, although crude glycerin may be preferred due to the cost. Up to 75% wt of glycerin may be added as a modifier, although preferred use of glycerin typically ranges from about 0.001% to 50% wt. In some embodiments, other polyols may be used. While any di or polyalcohol having at least two carbons may be used, in some embodiments the polyol may have from 2 to about 18 carbons. Exemplary polyols include, but are not limited to ethylene glycol, propylene glycol and diethylene glycol.

The adhesive composition may also include additives as commonly known in the art. For example, the additive may include fillers, thickeners, dyes, pigments, dispersion aids, antifungal agents, and the like. In one embodiment the adhesive composition may also include an alkaline earth metal. The alkaline earth metal may be added to raise the pH of the adhesive, denature soy (when present) and act as a chelating agent. Desirably, in some embodiments, the alkaline earth metal is a hydroxide of an alkaline earth metal and more preferably the alkaline earth metal is calcium in the form of lime. The alkaline earth metal may be added from about 0.1% wt to about 5% wt. In another embodiment an additive to reduce the propensity to produce foaming of the adhesive composition may be added. One example of a reagent to reduce foam is FoamKill, commercially available from Advantage Chemicals Ltd, UK. Additives to reduce foaming may typically be added from about 0.001% wt to about 20% wt.

The adhesive composition may be prepared using any method known to be useful to those of ordinary skill in the art. In one embodiment, the adhesive composition is prepared by combining from about 5% by weight to 80% wt of polymer with water through stirring. From about 1% to 60% wt of the bio-derived component is then slowly added to obtain uniform consistency, this step may be repeated depending upon the amount of bio-derived component needed. Finally, about 0.0001% to 10% wt of a multivalent cation is added to the adhesive composition.

The adhesive composition may be prepared at a temperature range of about 50° F. to 100° F., or at about 60° F. to 90° F., or about 65° F. to 75° F. The resultant pH of the adhesive composition ranges from 7 to 11, or at about 8 to 11 or about 9 to 10. The solids content in the adhesive composition ranges from about 35% to about 50%, or at about 38% to 48% or about 40% to 45%. The resultant viscosity in the adhesive composition ranges from about 5,000 cps to 25,000 cps or about 10,000 cps to 20,000 cps or 10,000 cps to 15,000 cps.

The present adhesive composition may be applied to different lignocellulosic components including but not limited to wood. The amount of adhesive composition applied to the pieces may vary considerably.

In one embodiment wood loadings of about 1% to about 45% percent by weight, specifically about 4% to about 30% percent by weight, and more specifically about 5% to about 20% percent by weight, of nonvolatile adhesive composition, based on the dry weight of the wood pieces, is suitable for preparing most wood composite products. In the making of plywood, the adhesive usage is generally expressed as “glue spreads”. Glue spreads of about 50 lbs to about 110 lbs of adhesive per about 1000 square feet of glue line are used when a veneer is applied to both sides, and glue spreads of about 25 lbs to about 55 lbs are used when the glue is spread on only one side of the veneer.

The adhesive composition may be used to adhere lignocellulosic components together. Lignocellulosic materials are cellulosic materials, which are the basic raw materials for articles, may be derived from a large number of natural sources. Suitable sources include sugar cane bagasse, straw, cornstalks, and other waste vegetable matter. In particular, however, they are derived form various species of wood in the form of wood fibers, chips, shavings, flakes, particles, veneers, and flours. Processed cellulosic materials include paper and other processed fibers. As is conventional in the art, the adhesive composition is combined with or applied to such cellulosic substrate materials by various spraying techniques, whereas it is generally applied to veneers by coaters. Adhesive composition applied to the cellulosic components is referred to herein as a coating even though it may be in the form of small resin particles such as atomized particles, which do not form a continuous coating.

Specifically, the adhesive composition is suitable for preparing wood composites. The adhesive composition may be used with a variety of soft and hard woods, such as, for example, Fir, Pine, Larch, Cedar, Alder, Aspen, Basswood, Cottonwood, Chestnut, Magnolia, Willow, Butternut, Elm, Hackberry, Maple, Sweetgum, Sycamore, Tupelo, Walnut, Poplar, Ash, Beech, Birch, Hickory, Madrone, Maple, Oak, Balsa and combinations comprising at least one of the foregoing, and the like.

Wood composites such as oriented strand board, particleboard, flake board, medium density fiberboard, waferboard, and the like are generally produced by applying the adhesive composition to the wood pieces, such as by blending or spraying the processed lignocellulose materials (wood pieces) such as wood flakes, wood fibers, wood particles, wood wafers, wood strips, wood strands, or other comminuted lignocellulose materials with an adhesive composition while the materials are tumbled or agitated in a blender or equivalent apparatus. When making plywood (such as hardwood plywood for interior applications), the adhesive composition may be applied to the veneers by roll coater, curtain coater, spray booth, foam extruder and the like.

### EXAMPLES

The following examples are intended to be illustrative only and are not intended to be limiting thereto.

A “3 cycle soak” test is a standard plywood industry test ANSI/HPVA HP-1-2004, which is incorporated herein in its entirety by reference, wherein 127 mm by 50.8 mm (5 inches by 2 inches) specimens from each test panel of plywood are submerged in water at 24 plus or minus 3° C. for 4 hours and then dried at a temperature between 49 and 52° C. for 19 hours with sufficient air circulation to lower the moisture content of the specimens to within the range of 4 to 12 percent of the overall dry weight of the panel The cycle is repeated until all specimens fail or until three cycles have been completed, whichever occurs first. A specimen is considered to fail when any single delamination between two plies is greater than 50.8 mm in continuous length, over 6.4 mm in depth at any point, and 0.08 mm in width, as determined by a feeler gage 0.08 mm thick and 12.7 mm wide. Delaminations due to tape at joints of inner plies or defects allowed by the grade are disregarded. Five of the six specimens must pass the first cycle and four of six specimens must pass the third cycle in 90% of the panels tested.

Within any given selection of test panels, 95% of the individual specimens must pass the first cycle and 85% of the specimens must pass the third cycle to achieve a “passed” rating.

In the following examples the following compositions were tested

| | |
|---|---|
| Crosslinkable | 45% solids styrene-acrylic co-polymer, with AAEM*, Visc <200 cP |
| Mixture A | pH = 9.5, AAEM was cut back by 4% compared to Crosslinkable |
| | Mixture E |
| Crosslinkable | 45% solids styrene-acrylic copolymer with styrene, butyl acrylate, and |
| Mixture B | 2.3% AAEM, 0.5% acid in polymer, and a co-polymerizable surfactant |
| Crosslinkable | 45% solids styrene-acrylic copolymer with styrene, butyl acrylate, and |
| Mixture C | 0% AAEM, 0.5% acid in polymer, and a co-polymerizable surfactant |
| Crosslinkable | 45% solids styrene-acrylic co-polymer with a glycidyl ether x-linking |
| Mixture D | group, 0% AAEM |
| Crosslinkable | 45% solids styrene-acrylic co-polymer, with AAEM, Visc <200 cP |
| Mixture E | pH = 9.5 |
| Crosslinkable | 45% solids styrene-acrylic co-polymer with AAEM, uses NaOH instead |
| Mixture F | of NH3 to neutralize |
| Crosslinkable | 45% solids styrene-acrylic copolymer with styrene, butyl acrylate, and |
| Mixture G | 4.6% AAEM, 0.5% acid in polymer, and a co-polymerizable surfactant |
| Crosslinkable | 45% solids styrene-acrylic copolymer with styrene, butyl acrylate, and |
| Mixture H | 1% AAEM, 0.5% acid in polymer, and a co-polymerizable surfactant |
| HONEYMEAD | 50% protein soy flour |
| ARCON AF | 70% protein soy protein concentrate |
| Lime | Ca(OH)₂ |
| FoamKill | Commercially available from Advantage Chemicals Ltd, UK |

*Acetoacetoxy ethyl methacrylate

In examples 1-3 an adhesive composition was made and subjected to the three cycle soak test.

TABLE 1

| | Example 1 | Example 2 | Example 3 |
|---|---|---|---|
| Water | 39.63 | 42.89 | 33.42 |
| Crosslinkable Mixture A | 46.08 | 44.68 | 53.58 |
| Lime | 1.38 | 1.34 | 1.59 |
| ARCON AF | 11.06 | 10.72 | 8.22 |
| Copper Sulfate | 0.00 | 0.36 | 0.00 |
| 10% CuSO₄ Mixture | 0.00 | 0.00 | 3.18 |
| % solids | 32.72 | 31.95 | 33.71 |
| Results of three cycle soak test | Fail | Pass | Pass |

As seen from the data in Table 1, examples 2 and 3 passed the industry's standard 3 cycle soak test, while example 1 failed.

In examples 4-6 an adhesive composition was made and subjected to the three cycle soak test.

TABLE 2

| | Example 4 | Example 5 | Example 6 | Example 7 | Example 8 |
|---|---|---|---|---|---|
| Water | 36.90 | 36.90 | 32.65 | 31.45 | 32.04 |
| Crosslinkable Mixture B | 50.92 | 50.93 | 0.00 | 0.00 | 0.00 |
| Crosslinkable Mixture C | 0.00 | 0.00 | 50.44 | 48.58 | 49.49 |
| Lime | 1.12 | 1.12 | 1.15 | 1.11 | 1.13 |
| ARCON AF | 8.81 | 8.81 | 0.00 | 0.00 | 0.00 |
| HONEYMEAD | 0.00 | 0.00 | 13.45 | 16.65 | 15.08 |
| 10% CuSO₄ Mixture | 2.24 | 2.24 | 2.31 | 2.22 | 2.26 |
| % solids | 34.35 | 34.35 | 38.79 | 41.05 | 39.94 |
| Results of three cycle soak | Pass | Pass | Fail | Fail | Fail |
| test | | | | | |

As seen from the data in Table 2, examples 4 and 5 passed the industry's standard 3 cycle soak test, while examples 6, 7 and 8 failed.

In examples 9-12 an adhesive composition was made and subjected to the three cycle soak test.

TABLE 3

| | Example 9 | Example 10 | Example 11 | Example 12 |
|---|---|---|---|---|
| Water | 32.00 | 33.33 | 32.78 | 66.11 |
| Crosslinkable | 50.00 | 49.63 | 50.64 | 0.00 |
| Mixture B | | | | |
| Lime | 1.00 | 0.00 | 1.16 | 1.85 |
| HONEYMEAD | 15.00 | 14.81 | 15.43 | 28.18 |
| 10% CuSO₄ | 2.00 | 2.22 | 0.00 | 3.85 |
| Mixture | | | | |
| % solids | 39.95 | 38.61 | 40.64 | 30.42 |
| Results of three | Pass | 1 Pass 1 Fail | Passed, yet | Fail |
| cycle soak test | | | poor knifing | |

As seen from the data in Table 3, examples 9 and 11 passed the industry's standard 3 cycle soak test, while examples 10 and 12 failed.

In example 13 an adhesive composition was made and subjected to the three cycle soak test.

TABLE 4

| | Example 13 |
|---|---|
| Water | 31.68 |
| Crosslinkable Mixture B | 49.50 |
| FoamKill | 0.99 |
| Lime | 0.99 |
| HONEYMEAD | 14.85 |
| 10% CuSO₄ Mixture | 1.98 |
| % solids | 39.0 |
| Results of three cycle soak test | Pass |

As seen from the data in Table 4, example 13 passed the industry's standard 3 cycle soak test with the addition of the FoamKill.

In examples 14-17 an adhesive composition was made and tested with bamboo and subjected to the three cycle soak test.

TABLE 5

| | Exam- | Exam- | Exam- | Exam- |
|---|---|---|---|---|
| | ple 14 | ple 15 | ple 16 | ple 17 |
| Water | 42.96 | 43.7 | 31.38 | 33.64 |
| Crosslinkable Mixture D | 49.9 | 44.92 | 0.00 | 0.00 |
| Crosslinkable Mixture E | 0.00 | 0.00 | 44.82 | 43.12 |
| Lime | 1.34 | 1.28 | 1.34 | 1.29 |
| ARCON AF | 10.25 | 9.75 | 22.46 | 21.60 |
| 10% CuSO₄ Mixture | 0.00 | 0.36 | 0.00 | 0.34 |
| % solids | 35.21 | 33.72 | 46.21 | 44.68 |
| Results of three cycle soak test | Pass | Pass | Pass | Fail |

As seen from the data in Table 5, examples 14-16 passed the industry's standard 3 cycle soak test, while example 17 failed.

In examples 18-21 an adhesive composition was made and subjected to the three cycle soak test.

TABLE 6

| | Exam- | Exam- | Exam- | Exam- |
|---|---|---|---|---|
| | ple 18 | ple 19 | ple 20 | ple 21 |
| Water | 34.54 | 36.36 | 31.07 | 32.76 |
| Crosslinkable Mixture A | 0.00 | 0.00 | 46.36 | 44.88 |
| Crosslinkable Mixture F | 51.55 | 49.80 | 0.00 | 0.00 |
| Lime | 1.55 | 1.49 | 1.39 | 1.35 |
| ARCON AF | 12.37 | 11.95 | 21.19 | 20.65 |
| Copper Sulfate | 0.00 | 0.40 | 0.00 | 0.36 |
| % solids | 39.69 | 38.60 | 45.76 | 44.66 |
| Results of three cycle soak test | Pass | Pass | Fail | Fail |

As seen from the data in Table 6, examples 18 and 19 passed the industry's standard 3 cycle soak test, while examples 20 and 21 failed.

In examples 22 and 23 an adhesive composition was made and subjected to the three cycle soak test.

TABLE 7

| | Example 22 | Example 23 |
|---|---|---|
| Water | 30.46 | 32.38 |
| Crosslinkable Mixture A | 50.76 | 49.07 |
| Lime | 1.52 | 1.47 |
| HONEYMEAD | 5.08 | 4.91 |
| ARCON AF | 12.18 | 11.78 |
| Copper Sulfate | 0.00 | 0.39 |
| % solids | 44.16 | 42.94 |
| Results of three cycle soak test | Pass | Pass |

As seen from the data in Table 7 examples 22 and 23 passed the industry's standard 3 cycle soak test.

In examples 24-26 an adhesive composition was made and subjected to the three cycle soak test.

TABLE 8

| | Example 24 | Example 25 | Example 26 |
|---|---|---|---|
| Water | 41.47 | 42.89 | 33.42 |
| Crosslinkable Mixture G | 46.08 | 44.68 | 53.58 |
| Lime | 1.38 | 1.34 | 1.59 |
| ARCON AF | 11.06 | 10.72 | 8.22 |
| Copper Sulfate | 0.00 | 0.36 | 0.00 |
| 10% CuSO₄ Mixture | 0.00 | 0.00 | 3.18 |
| % solids | 32.72 | 31.95 | 33.71 |
| Results of three cycle soak | Pass | Pass | Pass |
| test | | | |

As seen from the data in Table 8 examples 24-26 passed the industry's standard 3 cycle soak test.

In examples 27-33 an adhesive composition was made and subjected to the three cycle soak test.

TABLE 9

| | Example | Example | Example | Example | Example | Example | Example |
|---|---|---|---|---|---|---|---|
| | 27 | 28 | 29 | 30 | 31 | 32 | 33 |
| Water | 36.71 | 39.97 | 37.30 | 39.76 | 39.76 | 40.05 | 39.96 |
| Crosslinkable | 50.00 | 47.11 | 50.80 | 48.48 | 48.48 | 45.18 | 46.46 |
| Mixture D | | | | | | | |
| Lime | 0.00 | 0.00 | 1.45 | 1.39 | 1.39 | 0.00 | 1.33 |
| HONEYMEAD | 3.00 | 2.83 | 0.00 | 0.00 | 0.00 | 14.39 | 0.00 |
| ARCON AF | 10.29 | 9.69 | 10.45 | 9.97 | 9.97 | 0.00 | 11.86 |
| Copper Sulfate | 0.00 | 0.40 | 0.00 | 0.42 | 0.00 | 0.39 | 0.40 |
| Iron (III) | 0.00 | 0.00 | 0.00 | 0.00 | 0.42 | 0.00 | 0.00 |
| Chloride | | | | | | | |
| % solids | 38.29 | 36.33 | 37.30 | 35.86 | 35.86 | 37.22 | 36.67 |
| Results of three | Fail 3^{rd} | Fail 1^{st} | Fail 3^{rd} | Fail 3^{rd} | Fail 1^{st} | Fail 3^{rd} | Fail |
| cycle soak test | cycle | cycle | cycle | cycle | cycle | cycle | 60% |
| | | | | | | | pass 1^{st} |
| | | | | | | | cycle |
| | | | | | | | 40% |
| | | | | | | | pass 3^{rd} |
| | | | | | | | cycle |

As seen from the data in Table 9, examples 27-33 all failed the industry's standard 3 cycle soak test by some degree.

In example 34 an adhesive composition was made and subjected to the three cycle soak test.

TABLE 10

| | Example 34 |
|---|---|
| Water | 32.00 |
| Crosslinkable Mixture H | 50.00 |
| Lime | 1.00 |
| HONEYMEAD | 15.00 |
| 10% CuSO₄ Mixture | 2.00 |
| % solids | 39.95 |
| Results of three cycle soak test on White Fir | Pass |
| Results of three cycle soak test on Douglas Fir | Fail |

As seen from the data in Table 10, example 34 failed the industry's standard 3 cycle soak test for White Fir, but passed the test for Douglas Fir.

The singular forms “a,” “an,” and “the” include plural referents unless the context clearly dictates otherwise. The endpoints of all ranges reciting the same characteristic or referring to the quantity of the same component are independently combinable and inclusive of the recited endpoint. All cited patents, patent applications, and other references are incorporated herein by reference in their entirety.

While typical embodiments have been set forth for the purpose of illustration, the foregoing descriptions should not be deemed to be a limitation on the scope herein. Accordingly, various modifications, adaptations and alternatives may occur to one skilled in the art without departing from the spirit and scope herein.

We claim:

1. An adhesive composition substantially free of formaldehyde comprising:
at least one bio-derived component;
at least one multivalent cation; and
a polymer having at least one crosslinkable group;
wherein the polymer having at least one crosslinkable group is substantially free of epichlorohydrin.

2. The adhesive composition of claim 1, wherein the bio-derived component is an animal protein or a vegetable protein.

3. The adhesive composition of claim 2, wherein the vegetable protein is a soy protein.

4. The adhesive composition of claim 3, wherein the soy protein is added at a concentration of from about 1% to about 60% weight percent.

5. The adhesive composition of claim 1, wherein the multivalent cation is selected from the group consisting of: Ca++, Mg++, Mn++, Fe++, Fe+++, Cu++ and combinations thereof.

6. The adhesive composition of claim 5, wherein the multivalent cation is selected from the group consisting of Ca++, Cu++, and combinations thereof.

7. The adhesive composition of claim 1, wherein the crosslinkable group is selected from the group consisting of: carboxylic acid, esters, amides, 1,3 β dicarbonyl, glycidyl ether, oxirane, silane, siloxane, acetoacetoxyethyl methacrylate and combinations thereof.

8. The adhesive composition of claim 7, wherein the crosslinkable group is an acetoacetoxyethyl methacrylate.

9. The adhesive composition of claim 1, wherein the adhesive composition contains an alkaline earth metal.

10. The adhesive composition of claim 7, wherein the alkaline earth metal is calcium.

11. The adhesive composition of claim 1, wherein from 0.001% to 50% wt of flow improver is added.

12. The adhesive composition of claim 11 wherein the flow improver is selected from the group consisting of ethylene glycol, glycerin, propylene glycol, diethylene glycol and combinations thereof.

13. The adhesive composition of claim 12 wherein the flow improver is glycerin.

14. The adhesive composition of claim 1 wherein the adhesive composition is substantially free of Azetidinium moieties.

15. An article of manufacture comprising an adhesive of claim 1 and a lignocellulosic component.

16. The article of manufacture of claim 15 wherein the lignocellulosic component is selected from the group consisting of sugar cane bagasse, straw, cornstalks, and wood fibers, chips, shavings, flakes, particles, veneers, and flours.

17. The article of manufacture of claim 15 wherein the lignocellulosic component is wood selected from the group consisting of Fir, Pine, Larch, Cedar, Alder, Aspen, Basswood, Cottonwood, Chestnut, Magnolia, Willow, Butternut, Elm, Hackberry, Maple, Sweetgum, Sycamore, Tupelo, Walnut, Poplar, Ash, Beech, Birch, Hickory, Madrone, Maple, Oak, Balsa and combinations thereof.

18. The article of manufacture of claim 15 wherein the article comprises paper.

19. The article of manufacture of claim 15 wherein the article comprises oriented strand board, plywood, particleboard, flake board, medium density fiberboard, or waferboard.

20. A process for preparing an adhesive composition substantially free of formaldehyde comprising:
contacting at least one crosslinkable group in a polymer solution with water to produce a primary mixture;
mixing into the primary mixture at least one bio-derived component to produce a secondary mixture; and
mixing into the secondary mixture at least one multivalent cation;
wherein the at least one crosslinkable group is substantially free of epichlorohydrin.
